(19) United States
(12) Patent Application Publication
(10) Pub. No.: US 2018/0189852 A1
(43) Pub. Date: Jul. 5, 2018

(54) LEARNING BASED RECOMMENDATION SYSTEM AND METHOD

(71) Applicant: ELSE CORP S.r.l., Milano (IT)

(72) Inventor: Andrey Golub, Milano (IT)

(73) Assignee: ELSE CORP S.r.l., Milano (IT)

(21) Appl. No.: 15/809,670

(22) Filed: Nov. 10, 2017

(30) Foreign Application Priority Data
Dec. 29, 2016 (IT) 102016000132446

(51) Int. Cl. G06Q 30/06; G06N 99/00

(52) U.S. Cl. CPC G06Q 30/0621; G06Q 30/0631; G06N 99/005

(57) ABSTRACT

A system is provided that comprises least one processor, a user interface associated with a user and cooperating with the at least one processor, and a tool module defining instructions that, when executed by the at least one processor, cause the system to select by means of the user interface, manufacturing features of a first item to configure said first item, store in a database selection information associated with the selections of the manufacturing features made by the user via the user interface, analyze the stored selection information to learn style preferences associated with the user, and provide recommendations depending on the style preferences and relating to items to be configured by the user.

### BACKGROUND

### Technical Field

The present invention relates to recommendation systems.

### Description of the Related Art

In general, recommendation systems are information filtering systems that seek to predict the “rating” or “preference” that a user would give to an item. Such systems are utilized in a variety of areas: some popular applications include movies, music, news, books, research articles, search queries, social tags, and products in general.

Document US-A-20060282304 describes a system for an electronic product advisor where a suspect list of items that a user already owns or desires to own is programmatically acquired together with relevant-ratings, demographic, and behavioral data. This data is then compared to a database of product lists and ratings from similar users. A similarity measure is computed for each product list based on the number of similar products contained on the list that match the consumer's list, rankings, behavioral, and demographic data. A ranked list of recommended products that the consumer does not own is then computed based on the similarity measure and the editorial ratings of the product,

Further documents concerning recommendation techniques are:
T. Iwata et al., “Fashion Coordinates Recommender System using Photographs from Fashion Magazines”, (http://citeseerx.ist.psu.edu/viewdoc/download?do i-10.1.1.297.914&rep=rep1&type=pdf);
M. Jones, “Learn about the concepts that underlie web recommendation engines”, 12/12/2013, (https://www.ibm.com/developerworks/library/os-recommender1/);
H. Wang, “Machine fashion: an artificial intelligence based clothing fashion stylist” (http://www.ai.uga,edu/sites/default/files/theses/wang_haosha.pdf).

### BRIEF SUMMARY OF THE INVENTION

The Applicant has noticed that the known recommendation techniques are often unsatisfying in predicting customers preferences.

As an example, the above disadvantages can be overcome with a tool that makes a customer configure an item from a range of options and where the tool learns about customer's style preferences with the end objective of providing recommendations, to the customer or other entities, which are based on the style preferences determined by the tool itself, Particularly, such tool uses AI (Artificial Intelligence) to learn about a customer's style preferences,

According to a first aspect, the present invention relates to recommendation system as defined by the appended claim 1. Particular embodiments of the system are described by the dependent claims 2-9. In accordance with another aspect, the present invention relates to recommendation method defined by independent claim 10.

### BRIEF DESCRIPTION OF THE DRAWINGS

Further characteristics and advantages will be more apparent from the following description of a preferred embodiment and of its alternatives given as a way of an example with reference to the enclosed drawings in which:

FIG. 1 shows an example of a configuration and recommendation system;

FIG. 2 is a flow diagram representing an example of a configuration ad recommendation method;

FIG. 3 schematically shows an example of operation of said system;

FIG. 4 show an example of a configuration step implementable by said method.

### DETAILED DESCRIPTION OF EXAMPLES

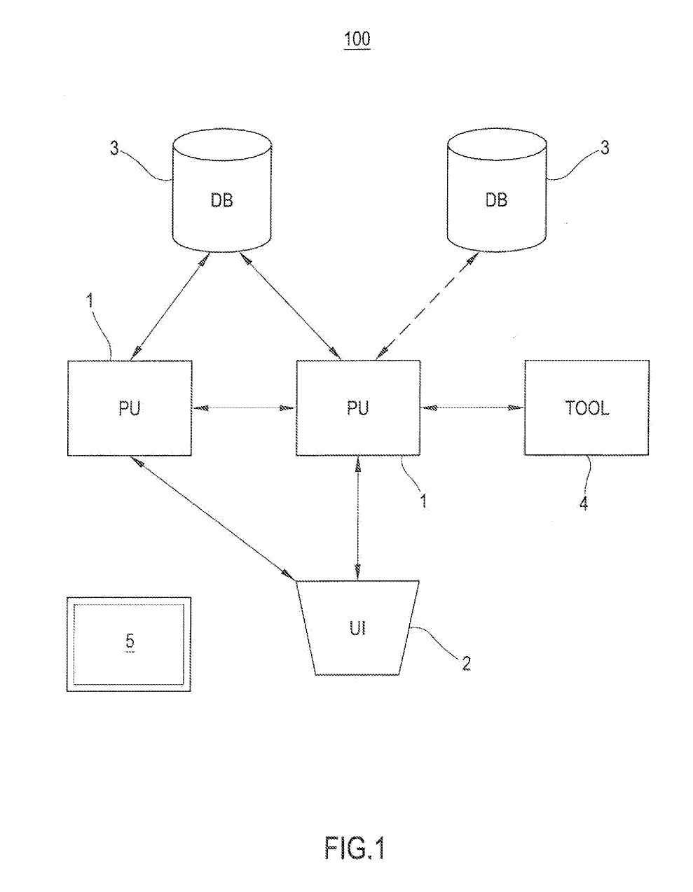

FIG. 1 refers to an example of a configuration and recommendation system 100 which is adapted to learn about customer's style preferences with the end objective of providing recommendation a configured item to the customer.

Particularly, the configuration and recommendation system 100 (hereinafter, also called “system”) is provided with the following devices: at least one processor 1 (PU), at least one user interface 2 (UI) and one or more databases 3 (DB). The above devices are interconnected each other, as an example, by a telematics net, such as the internet and/or they are part of a cloud or a combination of the two technologies. The connections between the above indicated devices can be wireless, wired or a combination thereof.

The at least one processor 1 can include, as an example, personal computers, mobile devices, servers and client computers. According to specific examples, the user interface 2 can be a mobile telephone, a personal computer, a tablet or virtual reality glasses or a keypad, a touch screen of a further electronic device. The user interface 2 can be part of a device having a processor unit that is one of the above mentioned at least one processor 1. The user interface 2 is associated with an user and cooperates with the at least one processor 1 and/or the database 3.

Preferably, the user interface 2 and/or the processor 1 are provided with a display 5 which can upload graphic interfaces useful for the user (also called customer) in operating with the system 100,

The system 100 is also provided with a tool module 4 which is a software module having instructions that can be executed by the at least one processor 1. The tool module 4 allows managing the interactions of the user interface 2 and the other devices to perform a configuring and recommendation method.

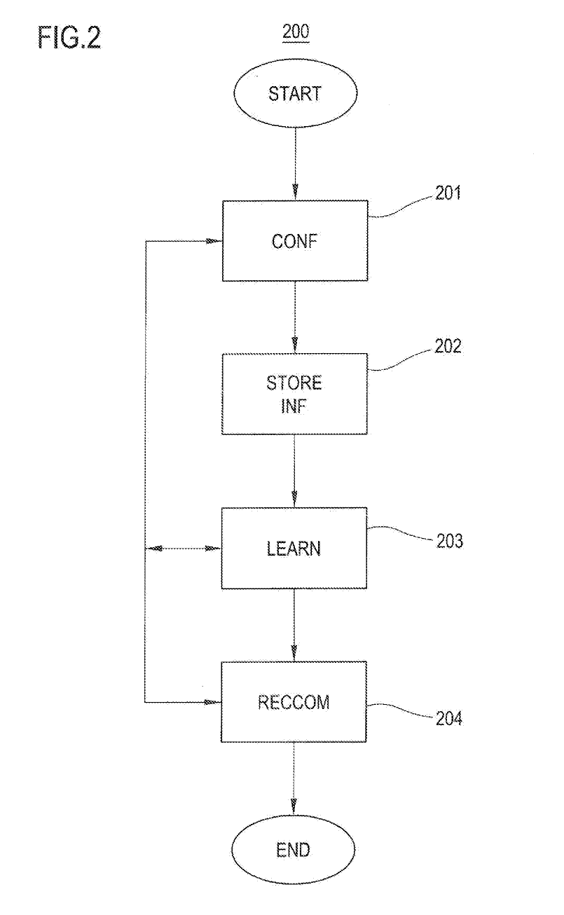

FIG. 2 shows, by a flow diagram, an example of the configuring and recommendation method 200 implementable by the tool module 4 of the system 1.

After a start step START, the configuring and recommendation method 200 provides for a first step 201 (CONF) in which the user, via the user interface 2, selects manufacturing features of a first item to be configured.

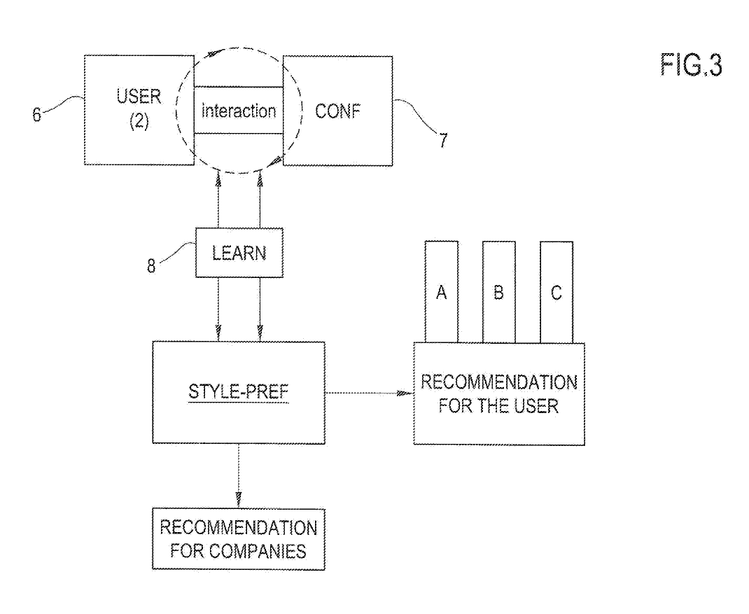

Particularly, the tool module 4 comprises a configuration module 7 (FIG. 3) which allows a user to configure a specific item by performing a plurality of choices among several options that are proposed to him by the system 100. Preferably, such options are proposed in a visual manner by displaying (as an example, on the display 5) words and/or images and/or symbols corresponding to such options. The representation of the items or part of the items can be made, as an example, using standard Avatar,

With the wording “to configure an item” it is meant to define a plurality of manufacturing features (among a pre-established set) so as to allow designing the item. As an example, the manufacturing features can relate to the shape of the item, the materials to be employed, the colors. Moreover, the configuration can relate to manufacturing essential elements and/or to accessory elements and/or purely decorative elements of the item. It is noticed that the item corresponding to the one configured by the user can be already available (i.e. it is already produced/manufactured) or it has to be manufactured according the configuration made.

Tool module 4 can be employed to configure item of different typologies, such as an example, items of clothing (for instance, gowns, suits or elements of them), fashion accessory (for instance, bags, bents etc.), footwear, jewelry, fashion jewelry, watches, accessories for electronic devices, design items, furniture, personal products, cars, etc.

According to an embodiment, the tool module 4 allows the user configuring an item from a wide range of unregulated options, similar to the configuration process on a ‘DIY Configurator’, where DIY stay for Do It Yourself.

The configuration and recommendation method 200 includes a second step 202 (STORE-INF) in which selection information are stored in the database 3; such selection information relates to the choices made by the user when he have selected the manufacturing features.

Furthermore, the tool module 4, in a third step 203 (LEARN), analyzes the stored selection information to obtain, i.e. to learn, style preferences associated with the user. Particularly, the tool module 4 is provided by a learning module 8 (FIG. 3) configured to use Artificial intelligence (AI) to learn about user's style preferences.

Moreover, the learning module 8, using the style preferences obtained in the third step 203, generates recommendations in a fourth step 204. Particularly, the recommendations relates to items to be configured by the same user in another configuration session or in the same configuration session. The learning module 8 performs a real-time analysis of user manipulations (i.e. selections) by means of mixing the given items parts and options in an intuitive way, towards creation of an “ideal” product configuration, which bring at certain point to satisfactory results, corresponding to the criteria, defined by the user himself: from the satisfactory results the recommendation are obtained.

The recommendations can be outputted by system. 100 to be provided to the user (e.g. via the user interface 2 or other components of the system 100) or can be provided to other entities. Particularly, it is observed that recommendations can be provided (e.g. to the user at any time throughout the configuration procedure (first step 201), i.e. also when the configuration procedure of the first step 201 is not already ended. The acceptance or the refusal of that recommendation by the user is another information to be employed by the learning module 8 to learn style preferences and provide further recommendation.

When the item configuration is completed according to user preferences, the user may proceed to a purchase order of the configured item; alternatively, it can save the data concerning the configuration made in a cart or in a “wish list”. The item as configured and ordered car; be produced and delivered to the user in the event of a specific product that is not available in the merchant's warehouse or, if already available, the item will be identified in a storeroom.

FIG. 3 is a schematic and symbolic representation of an example of operation of the system 100. In a configuration session, the user 6 via the user interface 2) interacts with the configuration module 7 (part of the tool module 4).

During such configuration, the user 6 is faced with options and performs his choices; the selection information, corresponding to the choices made, are processed by the learning module 8 (LEARN) operating, particularly, as an AI module, to obtain the style preferences STYLE-PREF that are suitably stored.

The recommendation outputted by the system 100 can be a “recommendation for the user” with which a suggestion on the item to be configured (chosen on the basis of the stored style preferences) is provided to the user 6, involved in the configuration session.

It is observed that, in accordance with a first specific example, the recommendation for the user can be an already configured item (output A) chosen from several catalogues of different companies, that the user can accept or modify during the configuration session.

According to a second example, the recommendation for the user can be an already configured item chosen from a catalogue of a specific company or brand (output B). This recommendation follows the rules and constraints set forth by the brand to stick to the brand's aesthetic and essential features.

In accordance with a third example the recommendation for the user can suggest improvements to the customer's configuration (output C). In this case, these suggestions for improvements are based on some rules and constraints inbuilt into the tool module 4.

According to another embodiment, the system 100 can output a “recommendation for companies” with which the stored style preferences and, preferably, further information on the user, are provided to companies (i.e. brands) and/or manufacturer. The knowledge of the style preferences will help companies to predict what offer to customers in future collections and/or impact on the trends. According to this embodiments these data are shared with brands for their future product developments.

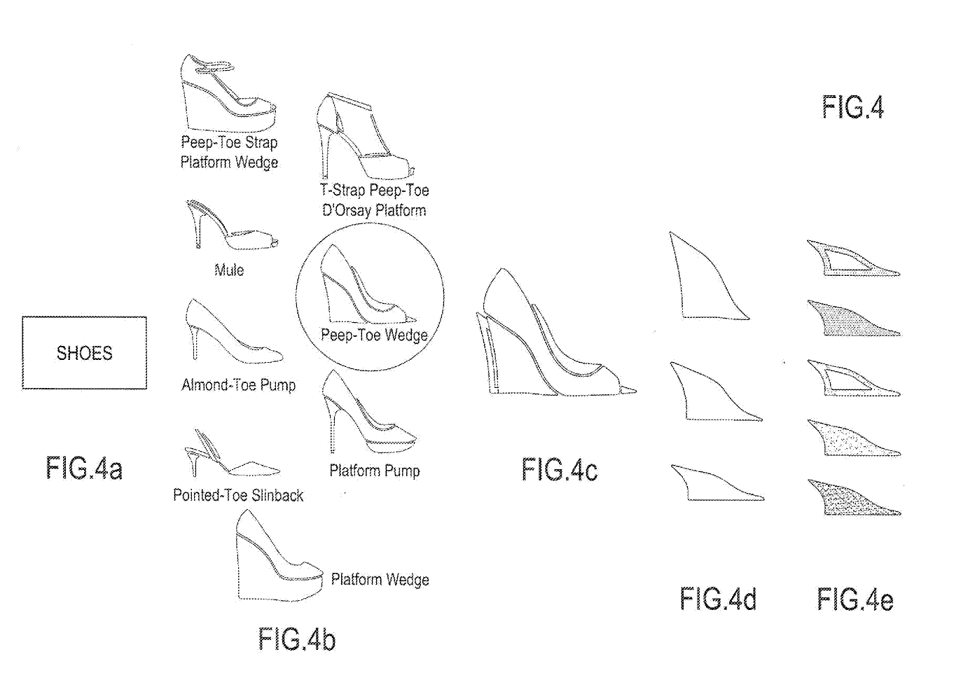

With reference again to the configuration step (i.e. first step 201 of FIG. 2) the users 6 may perform, as an example, the following actions (reference is made to FIG. 4):
select the item category he is interested in (e.g. a SHOE, FIG. 4a);
select the type of shoe (eg. PEEP-TOE WEDGE SHOE, FIG. 4b);
configure each part of the shoe (eg. HEEL, FIG. 4c), by selecting the type of part (e.g. WEDGE HEEL, FIG. 4d); and
select the type of materials and colors for that selected part (e.g. BLUE SUEDE, FIG. 4e);

The above actions will be repeated for each part of the selected item type till the user is satisfied with the configuration. The reference to a shoe is only explicative and not limitative.

According to the example of FIG. 4, an exemplary list of information that can be gathered by the tool module 4 in the third step 203 (leaning step) is:
the item category (FIG. 4a) that the user is probably most likely to purchase, since he have actively selected it;
the style of item and its connotation (FIG. 4b): a peep toe, for example, can be considered a more romantic/feminine/girly style of shoe than a pointed toe shoe;
the parts of the shoe chosen for configuration, (FIG. 4c), the type of the chosen part (FIG. 4d); the materials and colors for that selected part FIG. 4e): these information are related to the specific part of the product that is being configured.

So in this example where a heel is being configured, the user's choice of a lowest heel indicated the height that the user is most likely looking for and then the selection of color and material again indicate the preferences of the customer. These steps are repeated for each part of the shoe. The results are attached to the user's profile and result in recommended match products for the customer.

It is noticed that, the more a user uses the system 100, the more accurate the system can get and predict the user's likes and dislikes. For example, if four times out of five, a user selects an item with a lower heel, it is an indication that it is more probable that the user will buy a low heeled recommendation,

As an example, also the following information concerning the user's behavior and preferences can be deduced by the tool module 4 from the actions made by the user in the configuration step (first step 201):
the specific occasion/event users are looking for (for that specific instance),
the climate, so it impacts the types of products being recommended (if it is different from what is automatically predicted by the tool),
preferred shapes,
preferred colors,
preferred fabrics,
the preferred price range.

It is observed that the tool module 4 learns the user's preferences in a visual way since it learns about user's likes and dislikes from the selections (i.e. the positive choices) made during the configuration procedure, in which the proposed options are displayed. Particularly, the style preferences are not learned by directly asking the user what he likes or dislikes.

In addition, the toll module 4 can learn about customer's preferences basing on an open-ended set of properties and attributes, such as:
brand (e.g. “company name”)
silhouette (e.g. “jeans”)
shape (e.g. “slim cut”)
colour (e.g. “blue”)
material (e.g. “stonewashed cotton denim”)
target groups (e.g. “adult,” “male”)
price range
images selected or ‘disliked’ by the customer (like in the case of e-commerce sites)
customer and expert sentiments

In accordance with a particular embodiment, in order to gain more information on the taste of the user the system 100 and the tool model 4 are configured to incorporate other configurable and selectable elements that may impact on the inference of the preferred style of the customer. So, it is also possible to configure items which do not correspond to products but are general features not necessarily connected to a product, such as: color palettes, textures, images, environments . . . etc. . . .

The tool module 4 of the system 100 can be encountered by users in different possible ways such as: via web or in a physical store of a brand. With reference to the web mode, stand-alone website dedicated to the tool integrated in a brand's website or website integrated in a brand's website can be employed.

If the use of system. 100 is presented via a physical store of a brand, it can be a part of the configuration experience, to enhance the customer's product configuration. According to alternative solution the use of the system 100 can be presented as a software application offered as promotional activity, where a customer engages with the system and then the brand sends him a similar product at a discounted price. In another possible example, the software application can be provided as a marketing type gimmick.

Particularly, the tool module 4 and the system 100 are configured in such a way that when the customer encounters the tool the customer is aware that he is doing an activity that will enable the system 100 to learn their style preferences. Moreover, the user is also aware that at the end of the activity he will receive certain recommendations and that the data from their activity on the tool gets analyzed and stored.

Reference is now made to information that are already stored in the databases 3 of the system 100, in the case of an existing user. Particularly, the following information are already available and known to the system: customer's size; customer's morphology (Body Type); past purchase history; past browsing history; past configuration history; the location of the customer.

According to an example, the database 3 of system 100 also stores the following inbuilt information, that can be considered as input of the system 100, independent from a particular users: Fashion Trends (in general or specific to a brand's focus); Location based climate (spring, summer, autumn, winter, monsoon, . . . ); Cultural factors and influences; Body type specific recommendations; color theory. The inbuilt information can be used by the tool module 4 to infer the style preferences together with the information concerning the user selections.

With reference to the learning step (third step 203), the tool module 4 can be provided with additional sources of preference learning. According to a first additional methodology, since the tool module 4 can operate without keywords searches, the learning can be based on filters (such as: size, prize range etc.) determined by what the customer selects while configuring.

According to a second additional methodology, the configuration step (first step 201) allows cropping from, an item image part of the item that the user likes.

According to a third additional methodology, the tool module 4 allows the customer to input images of things that he likes and the user can highlight, the specific attribute that he like in that inputted image. As an example, from a picture of a shoe the heel highlighted. According to another example picture of a forest with the green leaves highlighted, indicating the color the customer likes.

According to a fourth additional methodology, the tool module 4, in learning the user's preferences, can use the “human” characteristics of a chat bot/siri like communication.

As regard the configuration of the item, the system 100 can be structured, as an example, in accordance with the system described in the Italian patent application No. 102016000088910.

The above described configuring and recommendation technique shows relevant advantages over the known techniques since it allows providing recommendations based on the actual customer preferences and so it is particularly reliable. The described configuring and recommendation techniques permits to better match customers' preferences with brand's selling activities. Moreover, the configuring and recommendation technique described above allows improving customization and personalization with respect to known methods.

1. A recommendation system comprising:
at least one processor;
a user interface associated with a user and cooperating with said at least one processor; and
a tool module defining instructions that when executed by the at least one processor, cause the system to:
select by means of the user interface manufacturing features of a first item to be configured;
store in a database selection information associated with the selections of the manufacturing features made by the user via the user interface;
analyze the stored selection information to learn style preferences of the user; and
provide recommendations depending on said style preferences and relating to items to be configured by the user,

2. The system of claim 1, wherein the system is structured to make said recommendations avaliable to the user.

3. The system of claim 2, wherein said recommendations available to the user indicate an already configured item chosen from several catalogues of different companies.

4. The system of claim 2, wherein said recommendations available to the user indicate an already configured item chosen from a catalogue of a specific company.

5. The system of claim 2, wherein said recommendations available to the user suggest improvements to the user's selection of the features of an item to be configured.

6. The system of claim 1, wherein the recommendations are provided to an external company to allow said external company predict what offers to send to users.

7. The system of claim 1, further comprising a learning module configured to analyze the stored selection information to learn the style preferences associated with the user which operates according to Artificial Intelligence technique.

8. The system of claim 1, wherein the system is configured to learn style preferences associated with the user from at least one of the following selection information: an item category selected by the user, a style of item, a part of the item selected for configuration, a selected type of the selected part; a material of the selected part, a color of the selected part,

9. The system of claim 1, wherein the tool module comprises a configuration module which allows a user to configure via said user interface a specific item by performing a plurality of choices among a plurality of options that are proposed to the user.

10. The system of claim 9, wherein the configuration module is configured to propose the plurality of options to the user in a visual manner by displaying the plurality of options on display,

11. A recommendation method, comprising:
providing at least one processor;
providing a user interface associated with a user and cooperating with said at least one processor;
selecting by means of the user interface manufacturing features of a first
item to be configured:
storing in a database selection information associated with the selections of the manufacturing features made by the user via the user interface;
analyzing the stored selection information to learn style preferences associated with the user;
outputting recommendations depending on said style preferences and relating to items to be configured by the user.
